(19) United States
(12) Patent Application Publication
(10) Pub. No.: US 2007/0267597 A1
(43) Pub. Date: Nov. 22, 2007

(54) Refrigerant Mixture of Dimethyl Ether and Carbon Dioxide

(75) Inventors: Seijyuro Maiya, Tokyo (JP); Osamu Nakagome, Tokyo (JP); Hideyuki Suzuki, Kanagawa (JP); Yasuhisa Kotani, Tokyo (JP); Toshifumi Hatanaka, Nara (JP); Toshihiro Wada, Chiba (JP)

Correspondence Address: THOMPSON COBURN, LLP, ONE US BANK PLAZA, SUITE 3500, ST LOUIS, MO, 63101, US

(73) Assignees: JAPAN PETROLEUM EXPLORATION CO., LTD., Tokyo (JP); SHOWA TANSAN CO., LTD., Tokyo (JP); NKK CO., LTD., Hyogo (JP)

(21) Appl. No.: 11/569,949

(22) PCT Filed: Jun. 1, 2005
(86) PCT No.: PCT/JP05/10036

§ 371 Date: Mar. 2, 2007

(30) Foreign Application Priority Data
Jun. 4, 2004 (JP) 2004-167211
Jun. 10, 2004 (JP) 2004-172851
Mar. 1, 2005 (JP) 2005-055957

(51) Int. Cl. C09K 5/00

(52) U.S. Cl. 252/69

(57) ABSTRACT

Disclosed is a safe, non-toxic refrigerant mixture for heating/hot water supply obtained by mixing dimethyl ether and carbon dioxide which operates at low pressures while exhibiting excellent performance. This refrigerant mixture does not deplete the ozone layer, and has a low global warming potential. Specifically disclosed is a composition containing 10-80% by mole of dimethyl ether and 90-20% by mole of carbon dioxide based on the total mole number of dimethyl ether and carbon dioxide.

### TECHNICAL FIELD

The present invention relates to a refrigerant composition containing dimethyl ether and carbon dioxide used for a heat pump hot water heater.

### BACKGROUND ART

Carbon dioxide has zero ozone-depleting potential, global warming potential of exactly 1 and extremely small environmental load as well as absence of toxicity, and flammability, safety, low price, and a low critical temperature of 31.1° C. Since in an air conditioning system and a hot-water supply system, heating can be performed even in a small temperature difference between the refrigerant and the refrigerated fluid due to readily attaining the supercritical point in a high pressure side of the cycling. As a result, in the heating process with large warm-up range as like hot-water supply, carbon dioxide is widely used as the refrigerant for a heat pump hot water supply under the naming of “ecocute,” since high coefficient of performance can be obtained; high heating ability in input volume per unit of compressor can be expected; and high thermal conductivity can be obtained.

However, since a working pressure of a carbon dioxide refrigerant is rather high as about 10 MPa compared with other refrigerants and as a result, each and every part of the system device should be assembled by super high pressure specifications, development of an elemental technology of the cycle system with appropriate prices remains a big issue.

### DISCLOSURE OF THE INVENTION

An object of the present invention is to provide a safe, non-toxic refrigerant mixture for hot water supply/heating as an alternative to carbon dioxide supercritical refrigerant. Such refrigerant mixture has a smaller risk for depleting the ozone layer, has small damaging effect on the global warming, exhibits incombustibility or fire retardancy, and operates at low pressures while exhibiting excellent performance.

Carbon dioxide has a critical temperature of 31.1° C. and a boiling point of −56.6° C., whereas dimethyl ether has a critical temperature of 126.85° C. and a boiling point of −25° C., indicating a great difference between the two in their physical property. For that reason, carbon dioxide is utilized as a refrigerant in a very high pressure region such as low pressure at about 3 MPa to high pressure at about 10 MPa, whereas dimethyl ether is utilized as a refrigerant in a comparatively low pressure region such as low pressure at about 0.7 MPa to high pressure at about 2 MPa, and is known to exert best performance as the refrigerant under such pressure condition. Consequently, although carbon dioxide and dimethyl ether have been used alone as the refrigerant, an idea of trying to utilize as the refrigerant by mixing carbon dioxide and dimethyl ether having completely different properties has not been made or examined.

Contrary to that, the inventors of the present invention have tried to perform an assessment test on solubility and a macroscopic test on solubility of carbon dioxide and have confirmed that although the amount of mass transfer (dissolved amount) to gas-liquid equilibrium is changed depending on the conditions of temperature and pressure, carbon dioxide was dissolved and diffused well in dimethyl ether. The inventors of the present invention have considered the possibilities of obtaining physical properties showing extremely high thermal efficiency by mixing carbon dioxide which is physically high efficiency of heat transfer (0.02 W/mK) and dimethyl ether which has higher specific heat (138 J/molK), continued the development and simulation, and found that the mixture of dimethyl ether and carbon dioxide was a refrigerant for heating/hot water supply which could operate at low pressures while exhibiting excellent coefficient of performance, and completed the present invention.

| | Carbon dioxide | Dimethyl ether |
|---|---|---|
| Specific heat (J/molK) | 30-40 | 138 |
| Thermal conductivity (W/mK) | 0.02 | 0.013 |

The present invention relates to a refrigerant composition for hot water supply/heating comprising 10-80% by mole of dimethyl ether and 90-20% by mole of carbon dioxide on the basis of the total number of moles of dimethyl ether and carbon dioxide.

### ADVANTAGES OF THE INVENTION

As explained hereinabove, a mixture of dimethyl ether and carbon dioxide of the present invention is a refrigerant which has superior heating and hot water supplying ability, does not deplete the ozone layer, has almost zero global warming potential, is safe and non-toxic, and operates at low pressure while exhibiting excellent performance.

### BRIEF DESCRIPTION OF THE DRAWINGS

FIG. 1 is Pattern diagram of hot water supply system.

FIG. 2 is DME CO₂ B programming flow-chart.

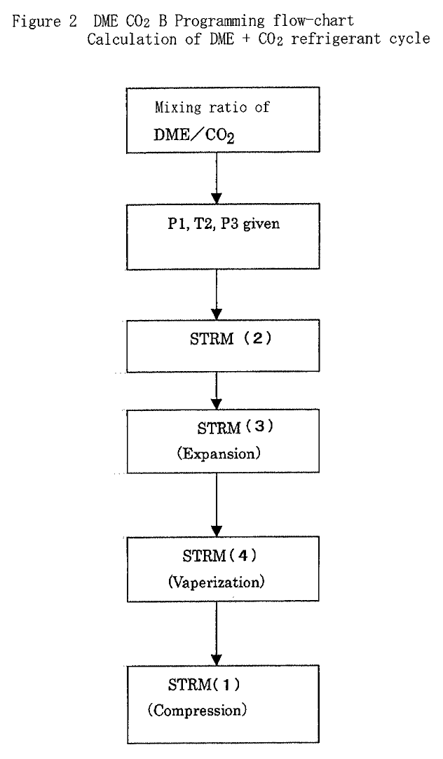

FIG. 3 is Experimental apparatus of DME/CO₂ mixed refrigerant cycle.

### BEST MODE FOR CARRYING OUT THE INVENTION

Preferable embodiments of the present invention will be explained in detail hereinbelow.

Dimethyl ether used in the refrigerant composition of the present invention can be obtained by synthesizing dimethyl ether directly from hydrogen and carbon monoxide or indirectly from hydrogen and carbon monoxide through methanol synthesis by utilizing raw material of a coal gasification gas, a BOG (boil of gas) of LNG tank, natural gases, by-product gases from a steel plant, oil residues, waste products and biogas.

Carbon dioxide used in the refrigerant composition of the present invention can be obtained by compression, liquefaction and purification of ammonium synthesis gas and by-product gas as the raw material generated from hydrogen manufacturing plant for desulfurization of fuel oil.

A mixed ratio of dimethyl ether and carbon dioxide in the refrigerant composition of the present invention is appropriately determined depending on types of a hot water supply/heater in which the refrigerant is used. The refrigerant composition of the present invention contains, on the basis of the total number of moles of dimethyl ether and carbon dioxide, preferably dimethyl ether at 10-80% by mole and carbon dioxide at 90-20% by mole, more preferably dimethyl ether at 30-70% by mole and carbon dioxide at 70-30% by mole. If a ratio of dimethyl ether is less than 10% by mole, a coefficient of performance hereinafter described unfavorably decreases. On the other hand, if the ratio of dimethyl ether is more than 80% by mole, the refrigerant composition tends to be flammable and is unfavorable on safety reasons.

The mixed ratio of the refrigerant composition of the present invention can be obtained, for example, by filling a predetermined amount of liquid dimethyl ether in a vessel from a tank filled with liquid dimethyl ether, subsequently filling a predetermined amount of liquid carbon dioxide thereto from a tank filled with liquid carbon dioxide. Further, after filling the predetermined amount of liquid dimethyl ether in the vessel, the refrigerant composition of the present invention can be prepared by such that carbon dioxide gas is filled into the gas phase part of the vessel and is dissolved and mixed under pressure into dimethyl ether.

In the refrigerant composition of the present invention, for example, water as another additive can be added. Since water can be dissolved about a little over 7% by mole in dimethyl ether under the conditions of 1 atmospheric pressure at 18° C., and has the characteristics of higher vaporization (condensation) latent heat as well as having a small rate of temperature change to the vaporization latent heat due to a high critical point, as a result large latent heat can be obtained even in a high-temperature region. Consequently, it is estimated to obtain further high thermal efficiency by admixing three types of substance, i.e. carbon dioxide having high sensible heat effect, and dimethyl ether and water both having high latent heat effect. A ratio of mixing water in this case is determined not to exceed 7% by mole in consideration of solubility to dimethyl ether.

Method for Evaluation of Refrigerant Characteristics

Hot Water Supply System

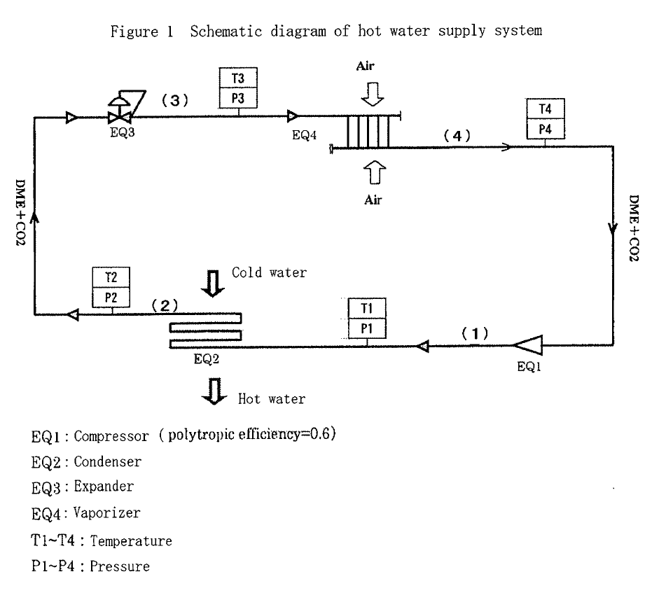

A hot water supply system is generally composed of a compressor, a condenser, an expander and a vaporizer as shown in FIG. 1, and hot water for hot water supply is generated by performing heat exchange between a high temperature refrigerant from the compressor and cold water at condenser. A working pressure in the condenser side becomes supercritical (CO₂ critical pressure: 7.4 MPa) at a high pressure of 9 MPa or more in the CO₂ refrigerant hot water supply cycle, the working pressure of the vaporizer in the low pressure side constitutes transition critical cycle of 3 MPa or more.

Simulation for Hot Water Supply Performance of CO₂/DME Refrigerant

In order to evaluate hot water supply performance of a CO₂/DME refrigerant, a numerical model of a standard cycle for hot water supply in FIG. 1 is prepared, and using the general-purpose simulation system for a numerical chemical process, the hot water supply performance of the CO₂/DME refrigerant can be analyzed and evaluated by the known method (e.g. see Miyara, Akio et al. “Effect of heat transfer characteristics of heat exchanger on non-azeotropic mixture refrigerant heat pump cycle,” Transactions of the Japanese Association of Refrigeration, 7(1):65-73, 1990). The general-purpose simulation system for the numerical chemical process stores database of thermodynamic properties of various components, and equilibrium thermodynamic calculation on interaction of chemical components corresponding to a mechanical engineering function of various systems can be performed.

In the numerical simulation, a system circulating the refrigerant composed of a compressor, a circulator, an expander and a vaporizer is expressed numerically, and the hot water supply performance is evaluated as coefficient of performance (COP) by using parameters of output pressure of compressor (P1), discharge temperature of condenser (T2), temperature of vaporizer (T3) and molar concentration of dimethyl ether/CO₂.
Hot water supply COP=total amount of exhaust heat of refrigerant in condenser÷amount of power of compressor

The present invention can be high precisely evaluated by applying, preferably as an estimate equation for thermodynamic physical value of refrigerant, regular solution model with respect to dissolution and SPK (Soave-Redlich-Kwong) equation of state with respect to the equation of state, respectively.

The refrigerant composition of the present invention can be fundamentally used in conventional carbon dioxide heat pump water supply known as naming of ecocute. However, considering the physical properties of the refrigerant of the present invention, a mechanical aspect of a condenser, a piston, etc. can be appropriately improved and designed in conformity with the refrigerant composition of the present invention.

### EXAMPLES

The present invention will be described with reference to examples hereinbelow in detail, however the present invention is not limited within these examples.

Solubility Test of Dimethyl Ether/Carbon Dioxide

In order to know solubility of a mixture system of dimethyl ether (DME) and carbon dioxide (CO₂), and in order to obtain coefficient of performance of the mixed refrigerant in the hot water supply described hereinbelow, a solubility test of DME/CO₂ was performed. The test method is as follows.

(1) 300 g of dimethyl ether was encapsulated and sealed in a 500-mL pressure vessel, and weight of the sealed vessel was measured by using electronic weighing machine.

(2) The pressure vessel was set in the constant-temperature bath and kept at a constant temperature.

(3) Carbon dioxide was injected by using a booster pump until obtaining a constant pressure.

(4) Weight of the filled carbon dioxide was calculated by weighing before and after filling (d=0.1 g).

In the filling, the pressure vessel was shaken up and down for completely mixing DME/CO₂, and the test was performed after allowing to stand vertically.

Results obtained are shown in Table 1. As shown in Table 1, a value of K-volume of CO₂ and DME is within the range of 0.66<KDME<0.80 and 2.59<KCO₂<3.42, respectively, indicating good solubility of carbon dioxide in DME.

TABLE 1
Solubility test results of DME/CO₂

Case

| | A | B | C | D |
|---|---|---|---|---|
| Pressure of system | 10.0 | 10.0 | 10.0 | 1.0 |
| Temperature of | 10 | 20 | 30 | 40 |
| system (° C.) | | | | |
| ZCO₂(g-mol) | 1.682 | 1.500 | 0.977 | 1.045 |
| ZDME(g-mol) | 6.522 | 6.522 | 6.522 | 6.522 |
| V(g-mol) | 1.177 | 1.378 | 2.090 | 0.661 |
| L(g-mol) | 7.027 | 6.634 | 5.409 | 6.906 |
| YCO₂ (mol %) | 43.2 | 42.9 | 26.3 | 39.0 |
| XCO₂ (mol %) | 16.7 | 13.7 | 7.9 | 11.4 |
| KCO₂(−) | 2.59 | 3.13 | 3.33 | 3.42 |
| YDME (mol %) | 56.8 | 57.1 | 73.7 | 61.0 |
| XDME (mol %) | 83.7 | 86.3 | 92.1 | 88.6 |
| KDME | 0.68 | 0.66 | 0.80 | 0.69 |

ZCO₂ = V*YCO₂ + L*XCO₂
ZCO₂ + ZDME = V + L
KCO₂ = YCO₂/XCO₂
KDME = YDME/XDME

### First Example

Coefficient of performance of the mixed refrigerant of dimethyl ether and carbon dioxide in the hot water system shown in FIG. 1 was obtained. Simulation using the simulation system for the numerical chemical process was performed by following operation procedures.

Simulation Procedure

A quantity of state of stream (1)-(4) (volume, enthalpy, entropy, etc.) in the hot water supply system in FIG. 1 was determined by simulation to obtain coefficient of performance (COP) of the following equation.
COP=H1/H2

H1: total amount of exhaust heat of refrigerant in condenser

H2: amount of power of compressor from (4) to (1)

Condition setting was as follows.

(1) CO₂ refrigerant alone

T2=15° C.

P1=9.2 MPa

P3=3.2 MPa

(2) CO₂/DME mixed refrigerant

In order to evaluate hot water supplying ability of CO₂/DME mixed refrigerant, the discharge pressure of the compressor, the steam pressure and the mixed ratio of CO₂/DME were used as fluctuating parameter for calculation.

P1=9.2-2.0 MPa

P3=0.5-3.2 MPa

mixed ratio of CO₂/DME (0%, 30%, 50%, 70% and 90%: mol fraction)

Vaporizing temperature of refrigerant: approximately 1° C.

Estimation of Gas-Liquid Equilibrium Physical Properties of DME+CO₂ Mixed System

In the simulation study, the accuracy of the employed estimation model for physical properties is an important factor and a trial examination was performed as follows.

In general, a gas-liquid equilibrium relation is expressed in the following equation.
φᵢPyᵢ=fᵢ⁽⁰⁾γᵢ⁽⁰⁾xᵢ×exp ∫₀^{P} V̅ᵢ^{L}/RT_{dp}
φᵢ: Gas phase Fugacity Coeff.
P: System Pressure
yi: Gas phase mol fraction
fᵢ⁽⁰⁾: Liquid phase standard Fugacity
γᵢ⁽⁰⁾: Activity coefficient of liquid phase
xᵢ: Liquid phase mol fraction
exp ∫₀^{P} V̅ᵢ^{L}/RT_{dp}: Poynting Facter

Points to be considered are following three points.

(1) γᵢ⁽⁰⁾ model for DME

(2) Degree of relative volatility of DME and CO₂

(3) Enthalpy and entropy model

Although DME is an oxygen containing low molecular weight compound, since the boiling point of the representative substance, ethanol, is 78° C., whereas that of DME is −25° C., it can be understood that it has no strong polarity as compared with alcohol, aldehyde and ketone groups. Consequently, a regular dissolution model can be applied for γᵢ⁽⁰⁾ of DME.

As obtained from DME/CO₂ solubility test data (Table 1), a values of K-volume of CO₂ and DME are within the range of 0.66<KDME<0.80 and 2.59<KCO₂<3.42, respectively, indicating that there is no large difference in volatility between DME and CO₂. Consequently, a vapor pressure model can be applied for fᵢ⁽⁰⁾.

Since the estimated maximum pressure for use in DME+CO₂ system with regard to enthalpy and entropy is approximately 10 MPa, SPK (Soave-Redlich-Kwong) equation of state can preferably be employed.

$$P = \frac{RT}{v - b} - \frac{{a [ 1 + ( 0.48 + 1.574 w - 0.176 {w}^{2} ) {( 1 - Tr )}^{1 \text{/} 2} ]}^{2}}{{v}^{2} + bv}$$

γᵢ⁽⁰⁾: Regular Solution Model
fᵢ⁽⁰⁾: Vaper Pressure Model
φᵢ, H, S: SRK equation of State
Poynting Facter: Considered

When pressure of the system becomes high in some degree (several MPa), Poynting factor cannot be negligible, consequently this point was taken into consideration.

Program

The following two programs, A and B were used.

(1) DME CO₂ A

Flash calculation under given composition, T (temperature) and P (pressure).

A bubble point was calculated under the given composition and P1 (compressor pressure).

According to this condition, confirmation for an accuracy of gas-liquid equilibrium physical property estimation model and whether total condensation in the condenser can be in sight.

(2) DME CO₂ B

Using the above explained simulator, COP of carbon dioxide alone and the refrigerant containing dimethyl ether and carbon dioxide, and those of control including R22, dimethyl ether alone and carbon dioxide alone were obtained as follows.

### Comparative Example 1

In the system shown in FIG. 1, COP of carbon dioxide 100% by mole was 3.44 in the discharge pressure=9.2 MPa, condenser discharge temperature=15° C. and vapor pressure=3.2 MPa, and in this case, the outlet temperature was 116° C., and T3/T4 vaporizing temperature was 1.2° C./1.2° C. In this cycle system, pressure from the discharge pressure to the vaporization pressure was operated under the supercritical pressure to the transition critical pressure.

### Example 1

In the same system, COP of the refrigerant containing 30% by mole of carbon dioxide and 70% by mole of dimethyl ether was 4.20 in the discharge pressure=2 MPa, condenser discharge temperature=15° C. and vapor pressure=0.55 MPa. In this case, the outlet temperature was 111° C. and T3/T4 vaporizing temperature was −12.8° C./11.6° C.

### Example 2

In the same system, COP of the refrigerant containing 50% by mole of carbon dioxide and 50% by mole of dimethyl ether was 4.28 in the discharge pressure=2.5 MPa, condenser discharge temperature=15° C. and vapor pressure=0.8 MPa. In this case, the outlet temperature was 111° C. and T3/T4 vaporizing temperature was −18.0° C./13.6° C.

### Example 3

In the same system, COP of the refrigerant containing 70% by mole of carbon dioxide and 30% by mole of dimethyl ether was 4.36 in the discharge pressure=3.5 MPa, condenser discharge temperature=15° C. and vapor pressure=1.3 MPa. In this case, the outlet temperature was 110° C. and T3/T4 vaporizing temperature was −16.8° C./14.8° C.

### Example 4

In the same system, COP of the refrigerant containing 90% by mole of carbon dioxide and 10% by mole of dimethyl ether was 3.90 in the discharge pressure=6 MPa, condenser discharge temperature=15° C. and vapor pressure=2.3 MPa. In this case, the outlet temperature was 110° C. and T3/T4 vaporizing temperature was −9.5° C./8.4° C. In this cycle system, pressure from the discharge pressure to the vaporization pressure was operated under the supercritical pressure to the transition critical pressure.

COP, expander discharge temperature, vaporizer discharge temperature and compressor outlet temperature obtained in each example are shown in Table 2. As obvious from Table 2, in Examples 1-4, a higher value of COP was obtained than in case of carbon dioxide alone, and the hot water supply system can be operated at very low discharge pressure as compared with the case of carbon dioxide alone.

TABLE 2
Comparative lists of thermodynamic characteristics of CO₂/DME mixed refrigerant

| | CO₂ | DME | | | Amount of | Discharge | Outlet | Vaporizing | Vaporizing |
|---|---|---|---|---|---|---|---|---|---|
| | concentration | concentration | | Electric power | heat liberation | pressure | temperature | pressure | temperature |
| | (%) | (%) | COP | W1 (KCAL/H) | H2 (Kcal/h) | P1 (MPa) | T1 (° C.) | P4 (MPa) | T3/T4 (° C.) |
| Comparative | 100 | 0 | 3.44 | 90660.0 | 3.12 × 10⁵ | 9.2 | 116 | 3.2 | 1.2/1.2 |
| Example 1 | | | | | | | | | |
| Example 1 | 30 | 70 | 4.20 | 128300.0 | 5.38 × 10⁵ | 2 | 111 | 0.55 | −12.8/11.6 |
| Example 2 | 50 | 50 | 4.28 | 112670.0 | 4.82 × 10⁵ | 2.5 | 111 | 0.8 | −18.0/13.6 |
| Example 3 | 70 | 30 | 4.36 | 96090.0 | 4.19 × 10⁵ | 3.5 | 110 | 1.3 | −16.8/14.8 |
| Example 4 | 90 | 10 | 3.90 | 87458.0 | 3.47 × 10⁵ | 6 | 110 | 2.3 | −9.5/8.4 |

From the above result, in the system operating at the condenser discharge temperature at 15° C. or less, the refrigerant composition of the present invention can be expected for utilization in the refrigerant for domestic hot water supply/heating system, the refrigerant for industrial air conditioning (heat pump) and refrigerating machine, and the refrigerant for heat pump utilizing geothermal heat to alleviate heat-island phenomenon.

### Second Example

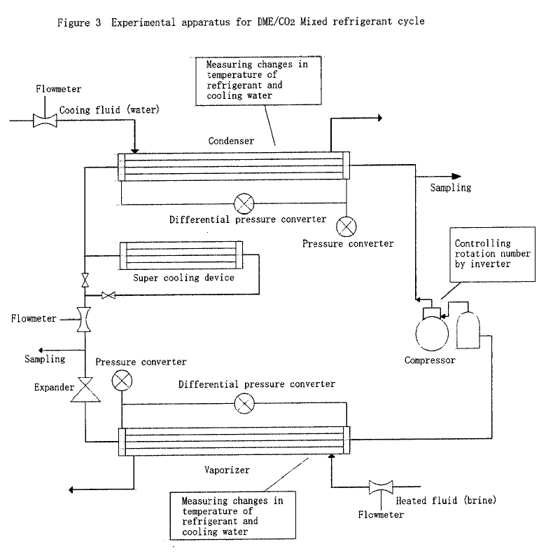

Experiment indicating what behavior of the dimethyl ether/carbon dioxide mixed refrigerant composition of the present invention exhibited in the actual hot water supply/heating system was performed. Outline of the apparatus used in this experiment is shown in FIG. 3. Fundamental construction of the experimental apparatus of the refrigerant cycle is the same hot water supply system as shown in FIG. 1, except that the super cooling device for controlling the temperature of the refrigerant is equipped after the condenser, and is composed of a vaporizer, a condenser, an expander and a compressor. Heat exchange inside the condenser and the vaporizer is achieved between the inner tube (refrigerant pass) and outer tube (water/brine pass) in the double tube. The system is constructed in such that length of the condenser and the compressor is 3.6 m and the temperature of the heat exchange water is measured at a distance of 30 cm and the temperature of the refrigerant is measured at a distance of 60 cm. A motor (500 W) for R410 was used as a source of power for the compressor and the frequency was 69 Hz.

Experimental condition is as follows.

Heat source water of condenser: inlet temperature: about 16° C., outlet temperature: about 46° C.

Flow volume: 10.7×10⁻³ kg/sec.

Heat source water of vaporizer: inlet temperature: about 6° C., outlet temperature: about −6° C.

Using the above apparatus and experimental condition, characteristics of the mixed refrigerant of dimethyl ether/carbon dioxide=74/26 (% by mole) were examined. The result indicated that the amount of heating added of the heat source water in the condenser (i.e. total amount of exhaust heat of the refrigerant in the condenser) was 1350 W and the input electric power (amount of power) was 382 W. COP is calculated as 3.53 from these measured values. The temperature of the refrigerant in the compressor (outlet temperature) was 93.4° C., and inlet temperature/outlet temperature of the refrigerant in the vaporizer was −11.7° C./−1.0° C. Consequently, the mixed refrigerant of dimethyl ether/carbon dioxide is shown to have effective hot water supplying ability in the actual refrigerant cycle.

The simulation in the First Example was performed with the mixed refrigerant, and the result indicated as follows: COP in the discharge pressure=1.5 MPa 3.2; outlet temperature 110° C.; and T3/T4 vaporizing temperature −11.7° C./−0.7° C.

Experimental values obtained for the experimental apparatus on refrigerant cycle using dimethyl ether/carbon dioxide=74/26 (% by mole) hereinabove and values obtained in the simulation experiment are shown in Table 3. As obvious from Table 3, experimental values and simulation values are well correlated. Consequently, result obtained from the simulation in the First Example can be said to reproduce precisely the refrigerant power revealed in the actual refrigerant cycle apparatus.

TABLE 3
Comparison of experimental value and simulation value
of DME/CO₂ (74/26% by mole) mixed refrigerant

| | Experimental | Simulation |
|---|---|---|
| | value | value |
| Inlet temperature of | −11.7° C. | −11.7° C. |
| refrigerant in vaporizer | | |
| Outlet temperature of | −1.0° C. | −0.7° C. |
| refrigerant in vaporizer | | |
| Temperature of | 93.4° C. | 110.0° C. |
| refrigerant in compressor | | |
| COP | 3.53 | 3.2 |

### Third Example

### Evaluation Test on Flammability

An evaluation test on flammability was performed according to a test method on flame length of Aerosol Industry Association of Japan. Test method is as follows.

Sample temperature: 24° C.-26° C.

Injection orifice of the sample blower was set on a position at 15 cm from the ignition burner.

The length of flame from the burner is adjusted to 4.5 cm −5.5 cm.

The refrigerant is injection sprayed in the best emission of jet spray by pressing the button for spray, and the vertical projection at the tip and end of the flame, i.e. horizontal distance of the flame, is measured at 3 seconds later as the length of flame.

The evaluation criteria are defined as follows.

x: Flame length of 20 cm or more (inflammable)

∘: Flame length of below 20 cm (slightly inflammable)

T: No flame (nonflammable)

Initial stage of blowing: Jet sprayed to 20% of the content

Middle stage of blowing: Jet sprayed to 50% of the content

Final stage of blowing: Jet sprayed to 80% of the content

Evaluation test on flammability of samples No. 1-5 shown in Table 4 was performed, and results are shown in Table 5.

TABLE 4
Samples for evaluation test on flammability

| | Sample No. | | | | |
|---|---|---|---|---|---|
| | 1 | 2 | 3 | 4 | 5 |
| DME (% by weight) | 100 | 95 | 90 | 80 | 70 |
| CO₂ (% by weight) | 0 | 5 | 10 | 20 | 30 |
| Pressure (MPa) | 0.5 | 0.8 | 1.0 | 1.5 | 1.7 |

TABLE 5
Test result on evaluation of flammability

Sample No.

| | 1 | 2 | 3 | 4 | 5 |
|---|---|---|---|---|---|
| Initial stage | x | ∘ | T | T | T |
| of blowing | | | | | |
| Middle stage | x | x | T | T | T |
| of blowing | | | | | |
| Final stage | x | x | x | ∘ | ∘ |
| of blowing | | | | | |

As obvious from the above results, even if dimethyl ether is mixed in an amount up to 80% by mole into carbon dioxide, it is found possible to provide nonflammable or flame retardant nature.

### Fourth Example

### Other Physical Properties of Refrigerant Composition

Other physicochemical properties of refrigerants measured for the refrigerant composition of the present invention, dimethyl ether alone, carbon dioxide alone and R22 are shown in Table 6. Saturated liquid density, latent heat of vaporization, heat conductivity of gas, fluid viscosity and gas viscosity herein are physical properties in operating state of the refrigerating machine.

As obvious from Table 6, the refrigerant composition of the present invention results in no differences from R22 in latent heat of vaporization, heat conductivity of gas and gas viscosity.

TABLE 6
Comparison on physicochemical properties of refrigerant

| Physicochemical property | R22 | CO₂ | DME | CO₂/DME | CO₂/DME |
|---|---|---|---|---|---|
| Molecular weight | 86.47 | 44.01 | 46.07 | CO₂:DME = 20%:80% | CO₂:DME = 50%:50% |
| Chemical formula | CHClF₂ | CO₂ | CH₃OCH₃ | CO₂/CH₃OCH₃ | CO₂/CH₃OCH₃ |
| Boiling point (1 atm) (° C.) | −40.8 | −56.6 | −25.0 | — | — |
| Critical temperature (° C.) | 96 | 31.05 | 126.9 | 120.0 | 90.0 |
| Critical pressure (MPa) | 5 | 7.34 | 5.4 | 5.3 | 6.5 |
| Molar specific heat at constant | 74 | 30-40 | 138.00 | — | — |
| pressure (1 atm)(J/molK) | | | | | |
| Saturated liquid density (Kg/m³) | 1170 | 1006 | 661.0 | 671.0 | 751.0 |
| Vaporizing latent heat (Kcal/mol) | 3.15 | 2.93 | 3.80 | 3.68 | 3.70 |
| Gas heat conductivity (Kcal/M · C · H) | 0.011 | 0.017 | 0.012 | 0.012 | 0.013 |
| Fluid viscosity (10⁻⁶ Pa · s) | 0.015 | 1.00 | 0.149 | 0.22 | 0.39 |
| Gas viscosity (10⁻⁶ Pa · s) | 0.012 | 0.016 | 0.008 | 0.01 | 0.01 |
| Ozone-depleting potential | 0.055 | 0 | 0 | 0 | 0 |
| Global warming potential | 1700 | 1 | 0 | 1 | 1 |
| Lifetime in the atmosphere (year) | 15 | 120 | 0.001 | 0.001 | 0.001 |
| Ignition temperature (° C.) | 0 | 0 | 350 | — | — |
| Explosion limit | 0 | 0 | 3-18 | — | — |

In case of CO₂ concentration of 100%, working compression pressure at 11 MPa results in a supercritical state.
In case of CO₂ concentration of 20% and DME concentration of 80%, working compression pressure at 2.0 MPa results in a supercritical state.
In case of CO₂ concentration of 50% and DME concentration of 50%, working compression pressure at 3.0 MPa results in a supercritical state

1. A refrigerant composition for hot water supply/heating comprising 10-80% by mole of dimethyl ether and 90-20% by mole of carbon dioxide on the basis of the total number of moles of dimethyl ether and carbon dioxide.

2. The refrigerant composition according to claim 1 comprising 30-70% by mole of dimethyl ether and 70-30% by mole of carbon dioxide.

3. A method of using a refrigerant composition comprising 10-80% by mole of dimethyl ether and 90-20% by mole of carbon dioxide on the basis of the total number of moles of dimethyl ether and carbon dioxide in a hot water supply apparatus/heater.
